(19) United States
(12) Patent Application Publication
(10) Pub. No.: US 2025/0309438 A1
(43) Pub. Date: Oct. 2, 2025

(54) BATTERY MODULE AND METHOD OF MANUFACTURING SAME

(71) Applicant: HONDA MOTOR CO., LTD., Tokyo (JP)

(72) Inventor: Hidemasa USUI, Saitama (JP)

(21) Appl. No.: 19/063,325

(22) Filed: Feb. 26, 2025

(30) Foreign Application Priority Data
Mar. 30, 2024 (JP) 2024-058341

(51) Int. Cl. H01M 50/242; H01M 50/204; H01M 50/289; H01M 50/682

(52) U.S. Cl. CPC H01M 50/242; H01M 50/204; H01M 50/289; H01M 50/682

(57) ABSTRACT

A battery module according to an aspect of the present invention includes: a cell stack in which a set of a plurality of battery cells are stacked; a pair of end plates disposed at opposite ends of the cell stack in a stacking direction, respectively; and a cushion disposed between the battery cells and/or between the set of the plurality of battery cells and each of the pair of end plates. The cushion is an at least one first cushioning member including an inner elastic container and an outer elastic container that houses the inner elastic container, the inner elastic container has an interior filled with a gas, a space between the inner elastic container and the outer elastic container is filled with a liquid, the outer elastic container is connected to a liquid pipe having an accumulator.

This application is based on and claims the benefit of priority from Japanese Patent Application No. 2024-058341, filed on 30 Mar. 2024, the content of which is incorporated herein by reference.

### BACKGROUND OF THE INVENTION

### Field of the Invention

The present invention relates to a battery module and method of manufacturing the battery module.

### Related Art

In recent years, research and development of battery modules that contribute to energy efficiency has been carried out in order to ensure many people have access to affordable, reliable, sustainable, and advanced energy. The battery module is formed by combining and modularizing a plurality of battery cells, and generally includes a cell stack in which the plurality of battery cells are stacked, and a pair of end plates disposed at opposite ends of the cell stack in the stacking direction. The battery module is used in applications requiring a large current and a high voltage, such as driving a motor of an electric vehicle or a hybrid electric vehicle.

Regarding the battery modules, studies are conducted on application of pressure in the stacking direction of battery cells by interposing a cushioning member between the battery cells or between the cell stack and the end plate. Known cushioning members include a cushioning member having a deformable chamber and a system for supplying a fluid for deforming the chamber (see Patent Document 1) and elastic spring bodies such as a leaf spring and a liquid spring (see Patent Document 2 and Patent Document 3).

Patent Document 1: Japanese Unexamined Patent Application, Publication No. 2020-64848

Patent Document 2: Japanese Unexamined Patent Application, Publication No. 2021-96974

Patent Document 3: European Patent Application, Publication No. 3886202

### SUMMARY OF THE INVENTION

A challenge for the techniques relating to battery modules is to increase the electrical capacity and reduce the size of the battery module. In order to increase the electrical capacity of a battery module, it is effective to apply a uniform pressure to the entirety of each of the battery cells incorporated in the battery module through cushioning members. A fluid cushion filled with a fluid has a highly uniform internal pressure, and therefore, can apply a highly uniform pressure to the entirety of each of the battery cells. A cushioning member including a liquid as the fluid is highly heat absorbent, and therefore, is effective in adjusting the temperature of the battery cells. On the other hand, a lithium metal battery as a battery cell is under study. In the lithium metal battery, lithium ions function as a charge transfer medium, lithium metal is precipitated on a negative electrode layer at the time of charge, and lithium ions deriving from the lithium metal are transferred to a positive electrode layer at the time of discharge. The lithium metal battery greatly changes in thickness due to charge and discharge. For this reason, in order to apply a uniform pressure to the lithium metal battery by means of a fluid cushion, it is necessary to reduce the amount of the internal fluid at the time of charge and to increase the amount of the internal fluid at the time of discharge. However, when a fluid tank is employed to adjust the amount of the internal fluid in the fluid cushion, it is difficult to reduce the size of the battery module.

The present invention has been made in view of the above circumstances, and an object of the present invention is to provide a battery module that can apply a uniform pressure to battery cells even in a case where the battery cells change greatly in thickness due to charge and discharge of the battery cells, and can be reduced in size. Another object of the present invention is to provide a method of manufacturing the battery module. The present invention contributes to energy efficiency by extension.

The present inventors have made the present invention based on the findings that the above objects can be achieved by a configuration in which a first cushion material having a double structure in which an inner elastic container filled with a gas and an outer elastic container are provided and a space between an outer surface of the inner elastic container and an inner surface of the outer elastic container is filled with a liquid is disposed between battery cells or between the battery cell and an end plate, and the outer elastic container is connected to a circulation pipe having an accumulator. Thus, the present invention provides the following.

A first aspect of the present invention is directed to a battery module including: a cell stack in which a set of a plurality of battery cells are stacked; a pair of end plates disposed at opposite ends of the cell stack in a stacking direction, respectively; and at least one first cushioning member disposed between the battery cells and/or between the set of the plurality of battery cells and each of the pair of end plates. The at least one first cushioning member includes an inner elastic container and an outer elastic container that houses the inner elastic container, the inner elastic container has an interior filled with a gas, a space between an outer surface of the inner elastic container and an inner surface of the outer elastic container is filled with a liquid, the outer elastic container is connected to a liquid pipe, and the liquid pipe is a circulation pipe having an accumulator.

According to the battery module of the first aspect, an increase in the liquid pressure of the liquid filling the space between the inner elastic container and the outer elastic container, which is caused when the thicknesses of the battery cells increase due to charge and the at least one first cushioning member is pressurized, can be suppressed by contraction of the inner elastic container and pressure accumulation in the accumulator. As a result, a uniform pressure can be applied to battery cells even in a case where the battery cells change greatly in thickness due to charge and discharge of the battery cells. In addition, since the accumulator is used as a tank for storing the liquid, size reduction is facilitated. Furthermore, since the liquid filling the at least one first cushioning member circulates through the circulation pipe and the liquid temperature becomes uniform, an increase in the temperature of the battery cells can be suppressed.

According to a second aspect of the present invention, in the battery module of the first aspect, the at least one first cushioning member has a configuration in which a total of a volume of the inner elastic container and a volume of the outer elastic container is defined as 100, and the volume of the inner elastic container is within a range of 30 or more and 70 or less with respect to the total.

According to the battery module of the second aspect, since the volume of the inner elastic container is within the above-described range, an increase in the liquid pressure of the liquid filling the interior of the at least one first cushioning member and an increase in the temperature of the battery cells can be suppressed in a more appropriately balanced manner.

According to a third aspect of the present invention, the battery module of the first aspect further includes at least one second cushioning member connected to the liquid pipe and having an interior filled with the liquid, the at least one second cushioning member being disposed between the battery cells and/or between the set of the plurality of battery cells and each of the pair of end plates.

The battery module of the third aspect is capable of more reliably suppressing an increase in the temperature of the battery cells because of the at least one second cushioning member that is filled only with the liquid and is highly heat absorbent.

According to a fourth aspect of the present invention, in the battery module of the third aspect, the at least one first cushioning member has a configuration in which a total of a volume of the inner elastic container and a volume of the outer elastic container is defined as 100, and the volume of the inner elastic container is within a range of 50 or more and 90 or less with respect to the total.

According to the battery module of the fourth aspect, since the volume of the inner elastic container of the at least one first cushioning member is within the above-described range, the large volume of the inner elastic container makes it possible to more reliably suppress an increase in the liquid pressure of the liquid filling the interiors of the at least one first cushioning member and the at least one second cushioning member.

According to a fifth aspect of the present invention, in the battery module of the third or fourth aspect, the at least one first cushioning member is disposed between one of the pair of end plates and the set of the plurality of battery cells, and the at least one second cushioning member is disposed between the battery cells.

According to the battery module of the fifth aspect, the second cushioning member disposed between battery cells makes it possible to more reliably suppress an increase in the temperature of the battery cells.

A sixth aspect of the present invention is directed to a method of manufacturing a battery module, the method including: providing a set of a plurality of battery cells, a pair of end plates, at least one double structure body including an inner elastic container and an outer elastic container that houses the inner elastic container; stacking the set of the plurality of battery cells to obtain a cell stack, followed by disposing the pair of end plates at opposite ends of the cell stack in a stacking direction, respectively, and disposing the at least one double structure body between the battery cells and/or between the set of the plurality of battery cells and each of the pair of end plates; filling the inner elastic container with a gas; and connecting the outer elastic container to a circulation pipe having an accumulator, followed by filling a space between the inner elastic container and the outer elastic container with a liquid.

The method of the sixth aspect makes it possible to industrially advantageously manufacture the battery module including the at least one first cushioning member described above.

The present invention provides a battery module that can apply a uniform pressure to battery cells even in a case where the battery cells change greatly in thickness due to charge and discharge of the battery cells, and can be reduced in size. The present invention further provides a method of manufacturing the battery module.

### BRIEF DESCRIPTION OF THE DRAWINGS

FIG. 1 is a schematic diagram illustrating a battery module according to a first embodiment of the present invention;

FIG. 2 is a cross-sectional view of a battery cell that can be used in the battery module according to the first embodiment of the present invention;

FIG. 3 is a schematic diagram illustrating a charged state of the battery module in FIG. 1;

FIG. 4 is a schematic diagram illustrating a battery module according to a second embodiment of the present invention; and

FIG. 5 is a schematic diagram illustrating a charged state of the battery module in FIG. 4.

### DETAILED DESCRIPTION OF THE INVENTION

Embodiments of the present invention will be described below with reference to the drawings. It should be noted the following embodiments illustrate the present invention by way of example, and the present invention is not limited to the following embodiments.

### First Embodiment

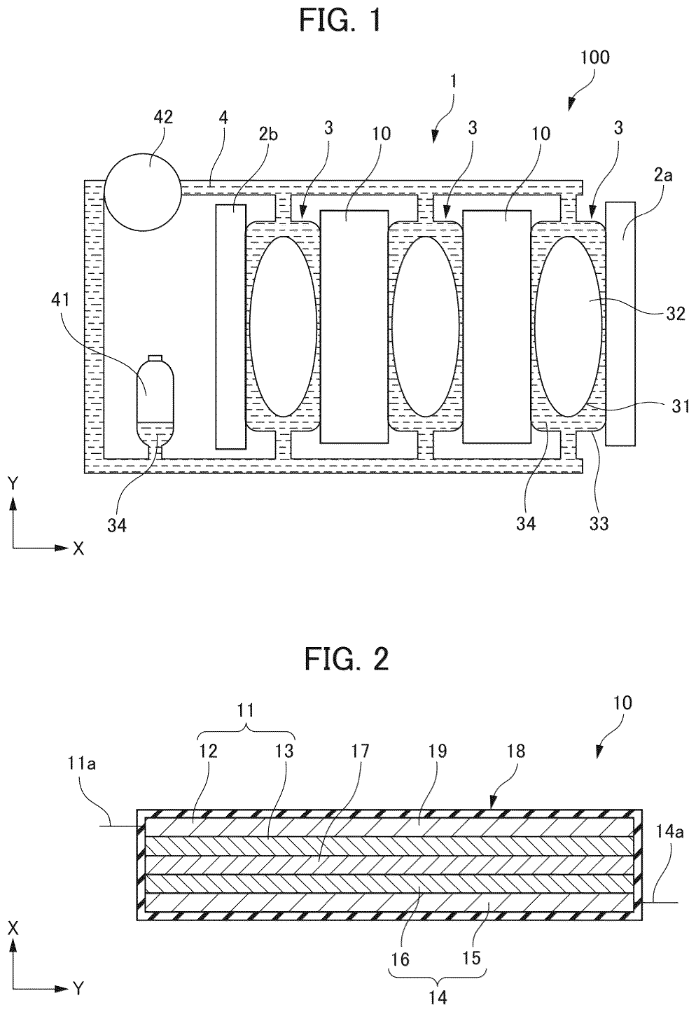

FIG. 1 is schematic diagram illustrating a battery module according to a first embodiment of the present invention. As illustrated in FIG. 1, the battery module 100 of the present embodiment includes a cell stack 1, a pair of end plates 2a and 2b, and first cushioning members 3. The cell stack 1 is a stack of a set of a plurality of (two in FIG. 1) battery cells 10 that are stacked. The end plates 2a and 2b are disposed at opposite ends of the cell stack 1 in the stacking direction (X direction in FIG. 1), respectively. The first cushioning members 3 are each disposed between the battery cells 10 and between the set of the plurality of battery cells 10 and each of the end plates 2a and 2b. The end plates 2a and 2b are fastened with a restraining tool such as a binding bar.

Each battery cell 10 is a lithium metal battery in which lithium ions serve as a charge transfer medium. As illustrated in FIG. 2, each battery cell 10 includes an electrode laminate 18 in which a positive electrode layer 11 and a negative electrode layer 14 are laminated with a solid electrolyte layer 17 interposed therebetween, and an exterior body 19 that houses the electrode laminate 18. The positive electrode layer 11 includes a positive electrode current collector 12 and a positive electrode active material layer 13. The negative electrode layer 14 includes a negative electrode current collector 15 and a metal layer 16. When the battery cell 10 is charged, lithium ions are released from the positive electrode active material layer 13, pass through the solid electrolyte layer 17, precipitate on a surface of the metal layer 16 of the negative electrode layer 14, and form a lithium precipitation layer, whereby the thickness of the negative electrode layer 14 increases. The lithium precipitation layer functions as a negative electrode active material layer, and is lost by releasing lithium ions during discharge. For this reason, the volume of each battery cell 10 changes due to charge and discharge. Therefore, the pressure that the battery cells 10 apply to the first cushioning members 3 changes due to charge and discharge. The stacking direction of the electrode laminate 18 is the same as the stacking direction of the cell stack 1. That is, the set of the plurality of battery cells 10 forming the cell stack 1 are stacked along the stacking direction of the electrode laminate 18. Although the battery cell 10 illustrated in FIG. 2 includes one electrode laminate 18 housed in the exterior body 19, a plurality of electrode laminates 18 may be housed in the exterior body 19.

The positive electrode current collector 12 may include any material and have any shape as long as the material and shape allow the positive electrode current collector 12 to have a function of collecting a current from the positive electrode layer 11. Examples of the material for the positive electrode current collector 12 include aluminum, an aluminum alloy, stainless steel, nickel, iron, titanium, etc., and among them, aluminum, an aluminum alloy, and stainless steel are preferred. Examples of the shape of the positive electrode current collector 12 include a foil shape, a plate shape, etc.

The positive electrode active material layer 13 contains at least one positive electrode active material. As the positive electrode active material, any of positive electrode active materials used in a positive electrode layer of a general solid secondary battery can be used, without any particular limitation. Examples of the positive electrode active material include a layered active material containing lithium, a spinel active material, an olivine active material, etc. Specific examples of the positive electrode active material include lithium cobalt oxide (LiCoO₂), lithium nickelate (LiNiO₂), LiNiₚMn_{g}COᵣO₂ (p+q+r=1), LiNiₚAl_{q}CoᵣO₂ (p+q+r=1), lithium manganate (LiMn₂O₄), hetero-element-substituted Li—Mn spinel represented by Li₁₊ₓMn_{2-x-y}MO₄ (x+y=2, and M is at least one selected from Al, Mg, Co, Fe, Ni, and Zn), lithium titanate (an oxide containing Li and Ti), and lithium metal phosphate (LiMPO₄, where M is at least one selected from Fe, Mn, Co, and Ni).

The positive electrode active material layer 13 may optionally contain a solid electrolyte from the viewpoint of improving lithium ion conductivity. Furthermore, the positive electrode active material layer 13 may optionally contain a conductive additive in order to improve electrical conductivity. Furthermore, the positive electrode active material layer 13 may optionally contain a binder from the viewpoint of imparting flexibility. The solid electrolyte, the conductive additive, and the binder are not particularly limited, and those used in a positive electrode layer of a general solid secondary battery can be used, without any particular limitation.

A positive electrode lead 11a is provided, and the material constituting the positive electrode lead 11a may be the same as or different from the material constituting the positive electrode current collector 12. The positive electrode lead 11a may be integrally connected to the positive electrode current collector 12.

The negative electrode current collector 15 may include any material and have any shape as long as the material and shape allow the negative electrode layer 14 to have a function of collecting a current. Examples of the material for the negative electrode current collector 15 include nickel, copper, stainless steel, etc. Examples of the shape of the negative electrode current collector 15 include a foil shape, a plate shape, etc.

The metal layer 16 may include any material and have any shape as long as the material and shape allows the metal layer 16 to have a function of making lithium ions densely precipitate. As the metal layer 16, a metal lithium layer or a layer of a metal that is alloyed with lithium can be used. Examples of the metal that is alloyed with lithium include Mg, Si, Au, Ag, In, Ge, Sn, Pb, Al, Zn, etc. The metal forming the metal layer 16 may be in the form of powder or a thin film. Using the negative electrode layer 14 including the metal layer 16 makes it possible to form a uniform lithium precipitation layer on a surface of the metal layer 16.

A negative electrode lead 14a is provided, and the material constituting the negative electrode lead 14a may be the same as or different from the material constituting the negative electrode current collector 15. The negative electrode lead 14a may be integrally connected to the negative electrode current collector 15.

The solid electrolyte layer 17 contains at least one solid electrolyte. The solid electrolyte is not particularly limited as long as it has lithium ion conductivity, and examples of the solid electrolyte include a sulfide solid electrolyte, an oxide solid electrolyte, a nitride solid electrolyte, a halide solid electrolyte, etc. Examples of the sulfide solid electrolyte include Li₂S—P₂S₅, Li₂S—P₂S₅—LiI, etc. The sulfide solid electrolyte may have an argyrodite type crystal structure. Examples of the oxide solid electrolyte include a NASICON type oxide, a garnet type oxide, and a perovskite type oxide. An example of the NASICON type oxide is an oxide containing Li, Al, Ti, P, and O (e.g., Li_{1.5}Al_{0.5}Ti_{1.5}(PO₄)₃). An example of the garnet type oxide is an oxide containing Li, La, Zr, and O (e.g., Li₇La₃Zr₂O₁₂). An example of the perovskite type oxide is an oxide containing Li, La, Ti, and O (e.g., LiLaTiO₃).

The exterior body 19 is capable of expanding and contracting in accordance with a change in the volume of the battery cell 10 caused by charge and discharge. The exterior body 19 may be constituted by a material such as a laminate film. The laminate film may have a three-layer structure in which an inner resin layer, a metal layer, and an outer resin layer are laminated in this order from the inner side. The outer resin layer may be, for example, a polyamide (nylon) layer or a polyethylene terephthalate (PET) layer, the metal layer may be, for example, an aluminum layer, and the inner resin layer may be, for example, a polyethylene layer or a polypropylene layer.

The end plates 2a and 2b have a function of restraining the cell stack 1 in the stacking direction. The end plates 2a and 2b exert a restraining force by way of which a surface pressure applied to the cell stack 1 through the first cushioning members 3 can be adjusted. The end plates 2a and 2b may be constituted by any of various materials used for end plates for battery modules, without any particular limitation.

The first cushioning members 3 have a function of making the surface pressure applied to the battery cells 10 uniform. The surface pressure applied to the battery cells 10 may be in a range of, for example, 1.0 MPa or more and 2.5 MPa or less.

Each first cushioning member 3 has a double structure including an inner elastic container 31 and an outer elastic container 33 housing the inner elastic container 31 therein. The interior of the inner elastic container 31 is filled with a gas 32. The gas 32 is filled in a hermetic manner. A space between the outer surface of the inner elastic container 31 and the inner surface of the outer elastic container 33 is filled with a liquid 34.

In each first cushioning member, the total of the volume of the inner elastic container 31 and the volume of the outer elastic container 33 is defined as 100, and the volume of the inner elastic container 31 may be, for example, in the range of 30 or more and 70 or less. The volume of the inner elastic container 31 refers to the volume filled with the gas 32. The volume of the outer elastic container 33 refers to the volume of the space between the outer surface of the inner elastic container 31 and the inner surface of the outer elastic container 33, that is, the volume filled with the liquid 34. In the case where the volume of the inner elastic container 31 is 30 or more, the pressure generated when the outer elastic container 33 is pressurized can be absorbed by the contraction of the inner elastic container 31, whereby an increase in the liquid pressure of the liquid 34 can be suppressed. In the case where the volume of the inner elastic container 31 is 70 or less, an increase in temperature of the battery cells 10 caused by the liquid 34 can be suppressed.

The inner elastic container 31 and the outer elastic container 33 are each made of a contractible elastic body. Examples of the materials for the inner elastic container 31 and the outer elastic container 33 include a rubber, an elastomer, a laminate film, etc. Examples of the gas 32 include air, a non-combustible gas (e.g., nitrogen, carbon dioxide, or the like), etc. Examples of the liquid 34 include a mineral-based hydraulic fluid, a phosphoric ester-based hydraulic fluid, water, a glycol-based solvent, etc.

A liquid pipe 4 is connected to side surfaces of the outer elastic containers 33 that are opposite to each other. The liquid pipe 4 is a circulation pipe provided with an accumulator 41 and a pump 42. The accumulator 41 suppresses an increase in the liquid pressure of the liquid 34 in the first cushioning members 3 by compressing and accumulating a gas in the accumulator 41. When the total volume of the accumulator 41 is defined as 100, the accumulator 41 may have a gas volume within a range of, for example, 30 or more and 70 or less. The pump 42 circulates the liquid 34 in the liquid pipe 4 and the first cushioning members 3. Circulating the liquid 34 can uniformize the liquid pressure and the liquid temperature of the liquid 34 in the liquid pipe 4 and the first cushioning members 3. When the liquid pressure is uniformized, the pressure that the first cushioning members 3 apply to the battery cells 10 becomes uniform. When the liquid temperature is uniformized, the temperature of the battery cells 10 becomes uniform.

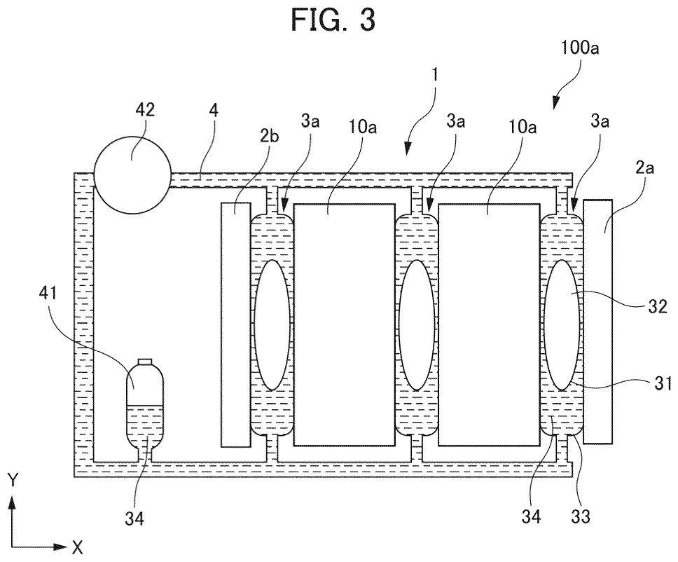

FIG. 3 is a schematic diagram illustrating a charged state of the battery module 100. In the battery module 100a in the charged state, the thickness of each battery cell 10a increases. Due to the increased thicknesses of the battery cells 10a, the first cushioning members 3a are pressurized to decrease in thickness. The decrease in the thicknesses of the first cushioning members 3a increases the liquid pressure of the liquid 34 in the first cushioning members 3a. The increase in the liquid pressure of the liquid 34 in the first cushioning members 3a pressurizes and causes the inner elastic containers 31 to contract, thereby causing a part of the liquid 34 in the first cushioning members 3a to flow out to the accumulator 41 via the liquid pipe 4. The accumulator 41 accumulates the increase in the liquid pressure by the contraction of the gas in the accumulator 41. Therefore, even when the thicknesses of the battery cells 10a increase, the internal pressure of the first cushioning members 3a does not excessively increase, and a uniform pressure can be applied to the battery cells 10a.

Each inner elastic container 31 has an effect of suppressing an increase in the liquid pressure of the liquid 34 in the first cushioning member 3, in cooperation with the accumulator 41. From the viewpoint of reducing the size of the accumulator 41, it is effective to increase the amount of the gas in each first cushioning member 3 by increasing the size of the inner elastic container 31. On the other hand, the liquid 34 has an effect of absorbing heat of the battery cells 10 and suppressing an increase in the temperature of the battery cells 10. From the viewpoint of suppressing an increase in the temperature of the battery cells 10, it is effective to increase the amount of the liquid in each first cushioning member 3 by widening the space between the inner elastic container 31 and the outer elastic container 33. Therefore, the inner elastic containers 31 may have different sizes depending on the locations where the first cushioning members 3 are disposed. For example, the first cushioning member 3 disposed between the battery cells 10 that are likely to increase in temperature may include a relatively small inner elastic container 31 such that the space between the inner elastic container 31 and the outer elastic container 33 is widened. The first cushioning members 3 disposed between the set of the plurality of battery cells 10 and each of the end plates 2a and 2b may include a relatively large inner elastic container 31. In the present embodiment, the first cushioning members 3 are disposed not only between the battery cells 10 but also between the set of the plurality of battery cells 10 and each of the end plates 2a and 2b, but the positions of the first cushioning members 3 are not limited thereto. It is sufficient that the first cushioning member 3 is disposed in at least one of: the locations between the battery cells 10; the location between the set of the plurality of battery cells 10 and the end plate 2a; or the location between the set of the plurality of battery cells 10 and the end plate 2b.

The battery module 100 of the present embodiment can be manufactured in the following manner, for example.

First, a set of a plurality of battery cells 10, a pair of end plates 2a and 2b, and double structure bodies each including an inner elastic container 31 and an outer elastic container 33 housing the inner elastic container 31 are provided.

Next, the set of the plurality of battery cells 10 are stacked to obtain a cell stack 1, the pair of end plates 2a and 2b are disposed at opposite ends in the stacking direction of the cell stack 1, respectively, and the double structure bodies are disposed between the battery cells 10 and between the set of the plurality of battery cells 10 and each of the end plates 2a and 2b. After the arrangement of these components is completed, the end plates 2a and 2b may be fastened with a restraining tool such as a binding bar.

Next, the inner elastic container 31 are filled with a gas 32. The pressure at the time of filling the inner elastic containers 31 with the gas 32 may be in the range of 0.1 MPa or more and 0.9 MPa or less. The filling of the inner elastic containers 31 with the gas 32 can be performed by the following process (1), (2), or (3), for example.
(1) A gas-supplying pipe is provided to each inner elastic container 31 in advance, the inner elastic container 31 is filled with the gas 32 through the pipe, and thereafter, a valve/joint having a check valve structure is installed at an end of the pipe.
(2) A gas-supplying pipe is provided to each inner elastic container 31 in advance, the inner elastic container 31 is filled with the gas 32 through the pipe, and thereafter, the pipe is sealed by heating or pressurizing.
(3) A gas-supplying pipe is provided to each thermoplastic inner elastic container 31 in advance, the inner elastic container 31 is filled with the gas 32 through the pipe, and thereafter, a portion of the inner elastic container 31 around the pipe is heated, followed by sealing the inner elastic container 31 at the time of removal of the pipe.

Next, a circulation pipe having an accumulator 41 is connected to each outer elastic container 33, and the space between the inner elastic container 31 and the outer elastic container 33 is filled with a liquid 34. After the liquid 34 is filled, the internal pressure of the accumulator 41 may be adjusted to a range of 1.0 MPa or more and 2.5 MPa or less.

According to the battery module 100 of the present embodiment having the above-described configuration, an increase in the internal pressure of the liquid filling the first cushioning members 3, which is caused when the thicknesses of the battery cells 10 increase due to charge and the first cushioning members 3 are pressurized, can be suppressed by contraction of the inner elastic containers 31 and pressure accumulation in the accumulator 41. As a result, even when the thicknesses of the battery cells 10 change greatly due to charge and discharge, a uniform pressure can be applied to the battery cells 10. In addition, since the accumulator 41 is used as a tank for storing the liquid 34, size reduction is facilitated. Furthermore, since the liquid filling the interiors of the first cushioning members circulates through the circulation pipe and the liquid temperature becomes uniform, an increase in the temperature of the battery cells can be suppressed.

In the battery module 100 of the present embodiment, in the case where the volume of the inner elastic container 31 is within the above-described range with respect to the total of the volume of the inner elastic container 31 and the volume of the outer elastic container 33 that is defined as 100, suppression of an increase in the liquid pressure of the liquid 34 filling the interiors of the first cushioning members 3 and suppression of an increase in the temperature of the battery cells 10 by the liquid 34 can be achieved in a more appropriately balanced manner.

According to the method of manufacturing the battery module 100 of the present embodiment, the battery module 100 described above can be industrially advantageously manufactured.

### Second Embodiment

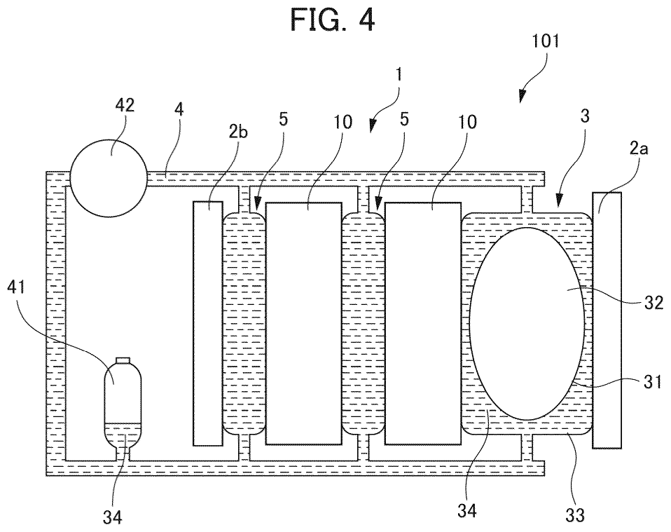

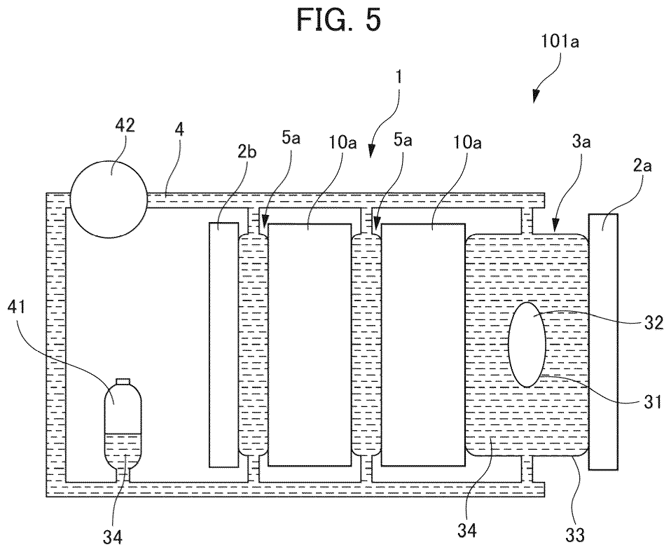

FIG. 4 is a schematic diagram illustrating a battery module according to a second embodiment of the present invention. FIG. 5 is a schematic diagram illustrating a charged state of the battery module in FIG. 4.

As illustrated in FIG. 4, the battery module 101 of the present embodiment is the same as the battery module 100 of the first embodiment except that second cushioning members 5 are disposed between battery cells 10 of a cell stack 1 and between the cell stack 1 and an end plate 2b. Accordingly, components common to the battery module 100 of the first embodiment are denoted by the same reference signs, and description thereof is omitted.

Each second cushioning member 5 is a cushion having an interior filled with only a liquid 34. A liquid pipe 4 is disposed on side surfaces of the second cushioning members 5 that are opposite to each other. The liquid pipe 4 is connected to the side surfaces of the second cushioning members 5 that are opposite to each other, and the liquid 34 in the second cushioning members 5 is also circulated. An accumulator 41 provided on the liquid pipe 4 may have a gas volume of 50 or more and 90 or less with respect to the total volume of the accumulator 41 defined as 100.

In the battery module 101a in a charged state, the thickness of each battery cell 10a increases. As a result, the first cushioning member 3a and the second cushioning members 5 are pressurized. Due to being pressurized, the first cushioning member 3a decreases in thickness, and the liquid pressure of the liquid 34 in the first cushioning member 3a increases. The increase in the liquid pressure of the liquid 34 pressurizes and causes the inner elastic container 31 to contract, thereby causing the liquid 34 to flow out to the accumulator 41 via the liquid pipe 4. Due to being pressurized, the second cushioning members 5 decrease in thickness, and the liquid pressure of the liquid 34 in the second cushioning members 5 increases, thereby causing the liquid 34 in the second cushioning members 5 to flow out to the accumulator 41 via the liquid pipe 4. Therefore, even when the thicknesses of the battery cells 10a increase, the internal pressure of the first cushioning member 3a and the internal pressures of the second cushioning members 5 do not excessively increase, and a uniform pressure can be applied to the battery cells 10a.

According to the battery module 101 of the present embodiment having the above-described configuration, an increase in the internal pressure of the first cushioning member 3 and an increase in the internal pressure of the second cushioning members 5, which are caused when thicknesses of the battery cells 10 increase due to charge and the first cushioning member 3 and the second cushioning members 5 are pressurized, can be suppressed by contraction of the inner elastic container 31 of the first cushioning member 3 and pressure accumulation in the accumulator 41. As a result, even when the thicknesses of the battery cells 10 change greatly due to charge and discharge, a uniform pressure can be applied to the battery cells 10. In addition, since the accumulator 41 is used as a tank for storing the liquid 34, size reduction can be achieved. Furthermore, according to the battery module 101 of the present embodiment, since the second cushioning members 5, which have interiors filled with only the liquid 34 and are highly heat absorbent, are disposed between the battery cells 10, thereby making it possible to efficiently suppress an increase in the temperature of the battery cells 10.

In the battery module 101 of the present embodiment, in the case where the volume of the inner elastic container 31 is within the above-described range with respect to the total of the volume of the inner elastic container 31 and the volume of the outer elastic container 33 that is defined as 100, the large volume of the inner elastic container 31 makes it possible to more reliably suppress an increase in the liquid pressure of the liquid 34 filling the first cushioning member 3 and the second cushioning members 5.

In the above embodiments, the battery cell 10 has been described as a solid-state battery including the solid electrolyte layer 17, but the battery cell 10 is not limited thereto. The battery cell 10 may be, for example, a nonaqueous battery including an organic electrolytic solution as an electrolyte or a polymer battery including a polymer gel (polymer).

### EXPLANATION OF REFERENCE NUMERALS

1: Cell stack
2a, 2b: End plate
3, 3a: First cushioning member
4: Liquid pipe
5: Second cushioning member
10, 10a: Battery cell
11: Positive electrode layer
11a: Positive electrode lead
12: Positive electrode current collector
13: Positive electrode active material layer
14: Negative electrode layer
14a: Negative electrode lead
15: Negative electrode current collector
16: Metal layer
17: Solid electrolyte layer
18: Electrode laminate
19: Exterior body
31: Inner elastic container
32: Gas
33: Outer elastic container
34: Liquid
41: Accumulator
42: Pump
100, 100a, 101 and 101a: Battery module

What is claimed is:

1. A battery module comprising:
a cell stack in which a set of a plurality of battery cells are stacked;
a pair of end plates disposed at opposite ends of the cell stack in a stacking direction, respectively; and
at least one first cushioning member disposed between the battery cells and/or between the set of the plurality of battery cells and each of the pair of end plates, wherein
the at least one first cushioning member includes an inner elastic container and an outer elastic container that houses the inner elastic container,
the inner elastic container has an interior filled with a gas,
a space between an outer surface of the inner elastic container and an inner surface of the outer elastic container is filled with a liquid,
the outer elastic container is connected to a liquid pipe, and
the liquid pipe is a circulation pipe having an accumulator.

2. The battery module according to claim 1, wherein
the at least one first cushioning member has a configuration in which a total of a volume of the inner elastic container and a volume of the outer elastic container is defined as 100, and the volume of the inner elastic container is within a range of 30 or more and 70 or less with respect to the total.

3. The battery module according to claim 1, further comprising:
at least one second cushioning member connected to the liquid pipe and having an interior filled with the liquid, the at least one second cushioning member being disposed between the battery cells and/or between the set of the plurality of battery cells and each of the pair of end plates.

4. The battery module according to claim 3, wherein
the at least one first cushioning member has a configuration in which a total of a volume of the inner elastic container and a volume of the outer elastic container is defined as 100, and the volume of the inner elastic container is within a range of 50 or more and 90 or less with respect to the total.

5. The battery module according to claim 3, wherein
the at least one first cushioning member is disposed between one of the pair of end plates and the set of the plurality of battery cells, and the at least one second cushioning member is disposed between the battery cells.

6. A method of manufacturing a battery module, the method comprising:
providing a set of a plurality of battery cells, a pair of end plates, at least one double structure body including an inner elastic container and an outer elastic container that houses the inner elastic container;
stacking the set of the plurality of battery cells to obtain a cell stack, followed by disposing the pair of end plates at opposite ends of the cell stack in a stacking direction, respectively, and disposing the at least one double structure body between the battery cells and/or between the set of the plurality of battery cells and each of the pair of end plates;
filling the inner elastic container with a gas; and
connecting the outer elastic container to a circulation pipe having an accumulator, followed by filling a space between the inner elastic container and the outer elastic container with a liquid.
